(19) United States
(12) Patent Application Publication
(10) Pub. No.: US 2025/0205905 A1
(43) Pub. Date: Jun. 26, 2025

(54) Robot Add-On Part, Control Device, Robot, and Associated Method

(71) Applicant: KUKA Deutschland GmbH, Augsburg (DE)

(72) Inventors: Juergen Blume, Friedberg (DE); Otmar Honsberg, Fuerstenfeldbruck (DE); Adam Tomiczek, Augsburg (DE)

(73) Assignee: KUKA Deutschland GmbH, Augsburg (DE)

(21) Appl. No.: 18/848,968

(22) PCT Filed: Mar. 31, 2023
(86) PCT No.: PCT/EP2023/058484

§ 371 Date: Sep. 20, 2024

(30) Foreign Application Priority Data
Apr. 6, 2022 (DE) 10 2022 108 243.1

(51) Int. Cl. B25J 15/04

(52) U.S. Cl. CPC B25J 15/0483

(57) ABSTRACT

A robot add-on part includes a coupling which is connectable in a form-fitting manner, arranged on the casing and designed for releasable coupling to at least one counter-coupling on an outer surface of a link of a robot. At least one control component is arranged on the casing or in the casing and includes a data memory in which physical data of the robot add-on part are stored. A control interface is designed and configured to transmit the physical data of the robot add-on part present in the data memory to a control device of the robot when the robot add-on part is coupled to the link.

### CROSS-REFERENCE TO RELATED APPLICATIONS

This application is a national phase application under 35 U.S.C. § 371 of International Patent Application No. PCT/EP2023/058484, filed Mar. 31, 2023 (pending), which claims the benefit of priority to German Patent Application No. DE 10 2022 108 243.1, filed Apr. 6, 2022, the disclosures of which are incorporated by reference herein in their entirety.

### TECHNICAL FIELD

The invention relates to a robot add-on part, comprising a casing and a coupling means which is connectable in a form-fitting manner, arranged on the casing and designed for releasable coupling to a counter-coupling means on an outer surface of a link of a robot. The invention moreover relates to an associated control device, a robot, and a corresponding method.

### BACKGROUND

DE 10 2015 206 575 A1 describes a robot-operated manual operating device, comprising a casing which has a handle-like grip section, a safety base control device arranged in the casing, and at least one holder which is connected to the casing and is designed for manually releasable mechanical coupling of the casing to a device which is different from the robot-operated manual operating device and which communicates electronically with the safety base control device, wherein the holder comprises a plug connecting means that is designed to be manually plugged to a mating plug connecting means of the device.

### SUMMARY

The object of the invention is to create a robot add-on part that can be optionally attached to a robot arm in a flexible configuration and removed again without the robot having to be manually reconfigured in terms of programming for this purpose.

The object is achieved by a robot add-on part, comprising:
a casing,
a coupling means which is connectable in a form-fitting manner, arranged on the casing and designed for releasable coupling to at least one counter-coupling means on an outer surface of a link of a robot,
wherein the coupling means is designed, in a state coupled to the link of the robot, in cooperation with the corresponding counter-coupling means of the link of the robot, to arrange the robot add-on part with regard to its position and orientation relative to the link of the robot to which the robot add-on part is coupled in the coupled state, with a position and orientation accuracy sufficient for the positioning accuracy of the robot,
at least one control component which is arranged on the casing or in the casing and comprises a data memory in which physical data of the robot add-on part are stored, and
a control interface which is designed and configured to transmit the physical data of the robot add-on part present in the data memory to a control device of the robot when the robot add-on part is coupled to the link of the robot.

The robot add-on part is completely housed within its own casing. The robot add-on part can be a device or device component that performs a specific technical function and is connected to the control system of the robot to which the robot add-on part is to be attached.

The robot add-on part can be, for example, a manual operating device, a safety emergency switching device, a sensor, and/or a camera.

In particular, robots that are designed to collaborate with humans often have a compliance control function that can be used to move the robot arm of the robot manually by pushing and/or pulling and to adjust its joint position configuration. This allows the robot to be programmed by demonstration. It is known that such robots have handles and/or electrical input means, for example on a link immediately upstream of the tool flange in the kinematic chain of links and joints of the robot arm, which handles and/or means are structurally designed as a unit with this link of the robot arm. This component is therefore part of the robot arm and thus not an add-on part that can be removed or reattached at will.

For ergonomic reasons, the aforementioned handles and/or electrical input means are often designed to protrude from the base contour of the robot arm, i.e., to project from the base surface of the link. Such projections or protrusions increase the overall geometric contour of the robot arm and must therefore be taken into account when modeling the robot arm and when programming movements of the robot arm. Since the projections or protrusions in permanently attached structures remain permanently unchanged, such interfering contours actually formed by the projections or protrusions can be taken into account in the modeling and programming at the factory during manufacture and basic configuration of the robot arm. However, here it is disadvantageous that the projections or protrusions can potentially become a hindrance during further use of the robot, for example if movements of the robot arm are to be programmed from the execution of a work task in which, for example, the space available is very tight and the fixed projections or protrusions of the robot arm may make it impossible to achieve a desired pose of the robot arm, since the fixed projections or protrusions of the robot arm would collide with walls, tools or workpieces, or other devices in the robot's workplace.

Since the casing of the robot add-on part inventively has at least one coupling means which is connectable in a form-fitting manner and is designed for releasable coupling to at least one counter-coupling means on an outer surface of a link of a robot, the robot add-on part in question can be removed from the robot arm when it is not required and/or when it would prevent a desired movement of the robot arm. This allows the robot add-on part to be removed from the robot arm and the corresponding projection or protrusion to be eliminated.

Optionally, one or more specific links or each of the links of the robot may have one or more counter-coupling means. Accordingly, at least one counter-coupling means is provided on the robot. If a plurality of counter-coupling means are provided on the robot, in particular a plurality of counter-coupling means on different links of the robot or on a specific link of the robot, the robot add-on part can optionally be attached at different locations, in particular in different positions and/or orientations on the robot, i.e., on the corresponding link of the robot.

This option of selectively attaching the robot add-on part to the robot arm or removing it from the arm changes the overall contour of the robot arm. However, this must then be taken into account when modeling the robot arm and when programming the robot arm's movements. Accordingly, when modeling the robot arm at least two different geometric models of the robot arm must be created or kept ready for programming. If two different robot add-on parts or a plurality of different robot add-on parts are possible, a corresponding number of geometric models of the robot arm must be provided.

Inventively, in order to simplify the configuration of the robot arm, it is now provided that the adaptation of the model should be possible automatically. This is achieved in that at least one control component arranged on the casing or in the casing of the robot add-on part comprises a data memory in which physical data of the robot add-on part are stored, and a control interface is provided which is designed and configured to transmit the physical data of the robot add-on part present in the data memory to a control device of the robot when the robot add-on part is coupled to the link of the robot. Thus, based on the physical data of the robot add-on part that is automatically read out from the robot add-on part, the robot model can be adapted accordingly, or an associated specific robot model that already exists can be selected for use.

The robot model can be a geometric model of the robot arm, or the robot model can include a geometric model as a component. In addition to a geometric model, the robot model can also include a kinematic model and/or a kinetic model.

So that after coupling the robot add-on part to a link of the robot arm, the exact position and orientation of the robot add-on part relative to the link of the robot arm is determined and thus known, the coupling means must be designed, in a state coupled to the link of the robot, in cooperation with the counter-coupling means of the link of the robot, to arrange the robot add-on part with regard to its position and orientation relative to the link of the robot to which the robot add-on part is coupled in the coupled state, with a position and orientation accuracy sufficient for the positioning accuracy of the robot.

Thus, the coupling means of the robot add-on part and accordingly also the counter-coupling means of the link of the robot to which it is coupled must be manufactured with sufficient geometric precision and, for example, have corresponding fits and/or locking means. A position and orientation accuracy sufficient for the positioning accuracy of the robot is achieved when the maximum deviations of the position and orientation of the robot add-on part with respect to the link of the robot to which it is coupled are smaller than, or at most equal to, the maximum tolerances of the positioning accuracy of the robot. The positioning accuracy of the robot is understood in particular to mean absolute accuracy and repeatability according to ISO 9283. For example, a typical absolute accuracy, such as path accuracy, can be in the range of 0.1 to 0.6 millimeters. For example, repeatability can be in a range of 0.03 to 0.1 millimeters.

In order to form a coupling means connectable in a releasable and form-fitting manner, the coupling means and the counter-coupling means on the robot arm can have corresponding (i.e., form-fitting with one another) projections, recesses, undercuts, and locking means. These projections, recesses, undercuts, and locking means can have fitting surfaces or fitting bodies which are manufactured with the required accuracy.

The coupling means and the counter-coupling means on the robot arm are designed to be releasable. A releasable design of the coupling means and counter-coupling means has the result that the coupling means can be separated from the counter-coupling means without the coupling means and/or the counter-coupling means being damaged or destroyed. A releasable design of the coupling means and the counter-coupling means also means that the coupling means and the counter-coupling means can be separated in a simple manner, in particular manually by the hands of a person, or at most with the aid of simple hand tools such as screwdrivers, wrenches, or pliers.

The control component arranged in the robot add-on part can, for example, be an electronic circuit board or can comprise a plurality of electronic sub-circuit boards. In addition to the data memory in which the physical data of the robot add-on part are stored, the control component can include other electronic components or assemblies which are required in particular for the corresponding technical functionality of the robot add-on part.

For example, in the case of a robot add-on part in the form of a manual operating device, the control component of the robot add-on part can have electrical switches, buttons, circuits, and/or manual control elements, such as joysticks, serving as input means. In this case, the control component can also include display means such as illuminants and/or electronic displays.

In the case of a robot add-on part in the form of a safety emergency switching device, this device can have an emergency stop button, an enabling button, and/or an operating mode selector switch and correspondingly assigned electrical circuits.

In an alternative or additional embodiment, the robot add-on part can have one or more sensors. In addition to the actual sensor element, the at least one sensor can also comprise an associated electronic sensor data evaluation unit.

However, another type of safety emergency switching device can also be implemented by a robot add-on part that only or exclusively has an emergency switching device that is designed and configured to act in an emergency situation in which, during human-robot collaboration, the human is inadvertently trapped between two links of the robot arm or between the robot arm and another object in the workplace and such a trapping situation is to be resolved, i.e., eliminated. To do this, the robot arm must be brought into a safe state by control technology, for example the motors of the robot arm must be switched off, which allows the trapped person to push the robot arm aside or away in order to be able to release the trapped body part from the trapping situation. Such a release from the trapping situation can therefore be triggered by manually operating an emergency switching device designed for this purpose. This device can be designed as a robot add-on part.

The robot add-on part can in particular be a camera, or can comprise a camera, which has an imaging sensor and optionally comprises an image evaluation circuit associated with the imaging sensor.

Finally, the robot add-on part has a control interface which is designed and configured to transmit the physical data of the robot add-on part present in the data memory to a control device of the robot when the robot add-on part is coupled to the link of the robot.

The control interface can be wired or can be a wireless interface. In the case of a wired interface, this can be integrated into the coupling means.

Accordingly, the wired interface can comprise electrical contacts which contact electrical counter-contacts on the link of the robot arm when the robot add-on part is coupled by means of its coupling means to the counter-coupling means of the link of the robot arm. The electrical contacts of the wired interface can be combined in a plug connector. In an analogous manner, the electrical counter-contacts on the link of the robot arm can be combined in a corresponding mating plug connector. The plug connectors and mating plug connectors can be designed to conform to a connector standard that supports a specific interface standard. For example, the plug connectors and mating plug connectors can be designed as plugs according to the USB standard and configured, for example, according to the known Thunderbolt (in particular Thunderbolt 4) interface protocol.

A radio connection (e.g. WPAN) can serve as a wireless interface. This interface can for example be configured according to the Bluetooth standard.

The physical data can be geometry data, center of gravity data, load data, and/or machine data of the robot add-on part.

The geometry data can describe the overall contour of the robot add-on part. Alternatively or additionally, the geometry data can be formed from a reduced data set. The reduced data set can, for example, include a central point within the overall contour of the robot add-on part and at least the length of a radius starting from this central point. Thus, an enveloping sphere can be determined by calculation using only the position or location of the central point and the radius. The enveloping sphere is to be defined in such a way that it completely encloses the robot add-on part. Such a reduced data set can be used to determine a complete envelope of the robot arm including the robot add-on part. Such a complete envelope of the robot arm can be used by the control device to automatically detect a collision situation when planning a movement of the robot arm in a predetermined environment.

The center of gravity data can contain information about the position or location of the center of gravity, or the center of mass, of the robot add-on part. The center of gravity data can be used to automatically determine forces and moments induced due to the mass of the robot add-on part attached to the robot arm when the robot arm is moved together with the attached robot add-on part, in particular when it is accelerated or decelerated. These forces and moments can be taken into account in a kinetic model of the robot arm.

In particular, when the robot add-on part is decoupled from an end link of the robot arm, i.e., decoupled from a tool flange of the robot arm, the physical data of the robot add-on part can be used as load data. These additional load data are required by the control device, for example, in order to be able to adapt the kinetic model of the robot arm to the variable loads that exist when a specific tool, which is to be detected by control technology using first load data, is uncoupled from the tool flange of the robot arm, or when another tool, which is to be detected by control technology using second load data, is uncoupled from the tool flange of the robot arm.

If the robot add-on part is coupled to a link of the robot arm other than the end link, i.e., the tool flange, the physical data of the robot add-on part are to be recorded as machine data rather than load data. By transmitting the physical data present in the data memory of the robot add-on part to the robot control device via the control interface when the robot add-on part is coupled to the link of the robot, the machine data can be automatically adapted to the new physical configuration of the robot arm that results when the robot add-on part is coupled to the link of the robot.

The robot add-on part can have a sensor which is assigned to the coupling means and designed to detect a proper coupling state of the coupling means of the robot add-on part to the counter-coupling means of the link of the robot, wherein the sensor is configured to allow transmission of the physical data from the memory of the robot add-on part to a control device assigned to the robot when a proper coupling state of the coupling means of the robot add-on part to the counter-coupling means of the link of the robot is detected by the sensor.

The sensor assigned to the coupling means can have a sensor device which detects whether the coupling means is properly, i.e., functionally correctly, coupled to the counter-coupling means on the relevant link of the robot arm, in particular whether it is locked into place. The sensor can then electronically transmit a signal to the control device which contains information as to whether the coupling means is properly, i.e., functionally correctly, coupled to the counter-coupling means on the relevant link of the robot arm.

The sensor, or a control component of the robot add-on part assigned to the sensor, can thus deliver a signal which allows or causes a transmission of the physical data from the memory of the robot add-on part to a control device assigned to the robot if the signal indicates a proper coupling state of the coupling means of the robot add-on part to the counter-coupling means of the link of the robot.

The control interface of the robot add-on part can be an electrical connector which is integrated into the coupling means and via which, when the robot add-on part is coupled to the robot link, the physical data stored in the memory are passed to the control device by means of an electrical connection routed via the electrical connector.

The electrical connector integrated into the coupling means can in particular be an electrical plug connector. The electrical plug connector can be designed as a plug, a socket, or a plug/socket combination. The electrical plug connector can comprise at least one electrical contact or a plurality of electrical contacts.

The control interface can thus comprise electrical contacts which contact electrical counter-contacts on the link of the robot arm when the robot add-on part is coupled by means of its coupling means to the counter-coupling means of the link of the robot arm. The electrical contacts of the wired interface can be combined in a plug connector. In an analogous manner, the electrical counter-contacts on the link of the robot arm can be combined in a corresponding mating plug connector. The plug connectors and mating plug connectors can be designed to conform to a connector standard that supports a specific interface standard. For example, the plug connectors and mating plug connectors can be designed as plugs according to the USB standard and configured, for example, according to the known Thunderbolt (in particular Thunderbolt 4) interface protocol.

The control interface of the robot add-on part can comprise a transmitting device which is part of a wireless connection which connects the control component of the robot add-on part to the control device of the robot.

A radio connection (e.g. WPAN) can serve as a wireless interface. This interface can for example be configured according to the Bluetooth standard.

The control interface of the robot add-on part can comprise a first data line which is designed using non-secure technology and is configured, when the robot add-on part is coupled to the link of the robot, to transmit data using non-secure technology to the control device in order to register the robot add-on part with the control device and to transmit the physical data to the control device, and the control interface of the robot add-on part can comprise a second data line which is designed using secure technology and is configured, when the robot add-on part is coupled to the link of the robot, to connect the control component with at least one of its functionalities to the control device using secure technology.

When the robot add-on part is coupled to a link of the robot arm, the robot add-on part can automatically register itself with the control device via the non-safety-relevant data connection, i.e., the first data line. The registration can trigger a control routine that configures the function assigned to the robot add-on part. For this purpose, the robot add-on part can transmit all necessary physical data from its data storage to the control device. If the robot add-on part has safety-relevant functionalities, such as a safety emergency switching device, an emergency stop button, an enabling button, and/or an operating mode selector switch, this safety-related functionality can then be set up via the safety-relevant data connection, i.e., the second data line.

The robot add-on part can be designed as a manual operating device, a safety emergency switching device, a sensor, and/or a camera, as already explained in more detail.

The object is also achieved by a control device which is designed and configured to control electric motors of a robot arm, which move joints of the robot arm in order to adjust links of the robot arm relative to one another either automatically according to a robot program implemented on the control device or in a manual drive mode by manual control, in order to move the robot arm into different poses, comprising an input interface to which a control interface of a robot add-on part according to one of the described embodiments is connected, such that data can be physically transmitted from the data memory of the robot add-on part to the control device.

In general, the control device can form a central controller, such as a robot controller, which contains all control components necessary for the operation of the robot arm, its modeling, for the connection of the robot add-on part, and/or for carrying out the method. Alternatively, the control device can have two or more decentralized control modules, which are then configured to interact in terms of control technology, for example in that the control modules are able to exchange signals, data, and/or information via communication connections.

The robot add-on part can thus be considered as part of the control device, or as a control means separate from the control device.

The object is also achieved by a robot comprising a robot arm with a plurality of joints and a plurality of links which can be adjusted relative to one another by moving the joints, wherein the joints are moved by means of electric motors of the robot arm in a manner controlled by a control device as described, wherein at least one of the links has at least one counter-coupling means to which a robot add-on part according to one of the described embodiments is coupled.

The counter-coupling means can have a control interface corresponding to the robot add-on part. This interface can be integrated into the counter-coupling means and can in particular comprise at least one electrical connector via which, when the robot add-on part is coupled to the link of the robot, the physical data stored in the memory of the robot add-on part are sent to the control device by means of an electrical connection routed via the electrical connector.

The electrical connector integrated in the counter-coupling means can in particular be an electrical plug connector. The electrical plug connector can be designed as a plug, a socket, or a plug/socket combination. The electrical plug connector can comprise at least one electrical contact or a plurality of electrical contacts. The electrical plug connector or the electrical contacts can be designed to correspond to those of the robot add-on part, i.e., when the robot add-on part is coupled to the relevant link of the robot arm, they can make electrical contact with these when the coupling means and the counter-coupling means are connected.

The object is also achieved by a method for controlling electric motors of a robot arm, which move joints of the robot arm in order to adjust links of the robot arm relative to each other either automatically according to a robot program implemented on the control device or in a manual driving mode by manual controlling in order to move the robot arm into different poses, comprising the steps:
attaching a robot add-on part according to one of the described embodiments to a link of a robot arm comprising a plurality of links by connecting, in a form-fitting manner, the coupling means of the robot add-on part to a counter-coupling means of one of the links of the robot arm,
automatic transmission of physical data from a data memory of the robot add-on part into a control device which is designed and configured to control a robot arm to which the robot add-on part is coupled,
controlling the electric motors of the robot arm by means of the control device automatically according to a robot program implemented on the control device or in a manual driving mode by manual control, wherein during a controlled execution of movements of the robot arm the physical data obtained from the robot add-on part are included in the planning of the movements of the robot arm.

Specific embodiments of the invention are explained in more detail in the following description with reference to the accompanying drawings. Specific features of these embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a perspective view of an exemplary robot arm,

FIG. 2 is a perspective view of an exemplary robot arm designed for human-robot collaboration, wherein a flange link of the robot arm has an inventive robot add-on part,

FIG. 3 is a perspective view of an exemplary robot arm designed for human-robot collaboration, wherein another link of the robot arm has an inventive robot add-on part,

FIG. 4 is a schematic representation of an inventive robot add-on part on a link of the robot arm, shown by itself, and

FIG. 5 shows a flow diagram of the basic inventive method.

### DETAILED DESCRIPTION

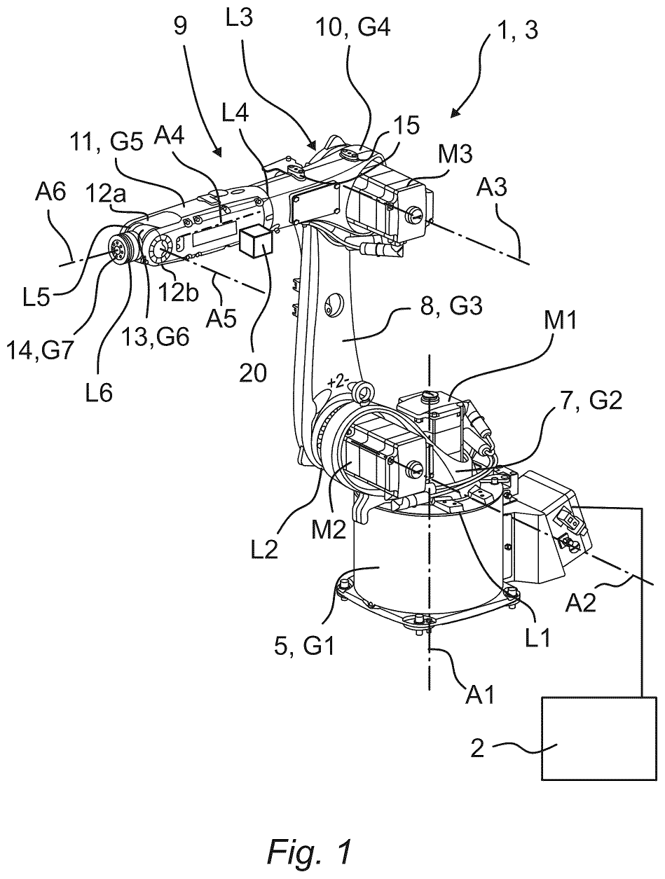

FIG. 1 shows an example of a robot 1 having a robot controller 2 and a robot arm 3. The robot arm 3 has a base frame 5 as a first link G1, on which a carousel 7, as a second link G2, is mounted so as to be rotatable about a first vertical axis A1, and is rotationally driven by means of a first drive motor M1. The axes A1-A6 of the robot arm 3 can also be referred to as joints L1-L6 of the robot arm 3. On the carousel 7, a link arm 8 is mounted as a third link G3 so as to be pivotable up and down about a second horizontal axis A2, and is rotationally driven by means of a second drive motor M2. The link arm 8 carries an arm extension 9, which is mounted so as to be pivotable up and down about a third horizontal axis A3 and is rotationally driven by means of a third drive motor M3. On the arm extension 9, whose base arm 10 forms a fourth link G4, a fourth axis A4 is provided which runs in the longitudinal extension of the arm extension 9 and, via a fourth drive motor (not shown), rotationally drives a front arm 11 which forms a fifth link G5. A first limb 12a and a second limb 12b extend forward in a fork shape from the front arm 11. The two limbs 12a, 12b carry a bearing for a hand 13, which forms a sixth link G6. The bearing defines a fifth axis A5 of the robot arm 3, about which the hand 13 can be pivotably moved by means of a fifth drive motor (not shown). In addition, the hand 13 has a sixth axis A6 in order to be able to rotationally drive a fastening flange 14, which forms a seventh link G7, by means of a sixth drive motor (not shown). Each axis A1 to A6 is assigned a joint L1 to L6, which joints L1 to L6, in the embodiment shown, connect the links G1 to G7 in the manner of a serial kinematic system of a kick arm robot. An inventive robot add-on part 20 can, as shown, be coupled to one of the links G1 to G7 of the robot arm 3, in the present case of FIG. 1 to the fifth link G5 of the robot arm 3, i.e., to the front arm 11.

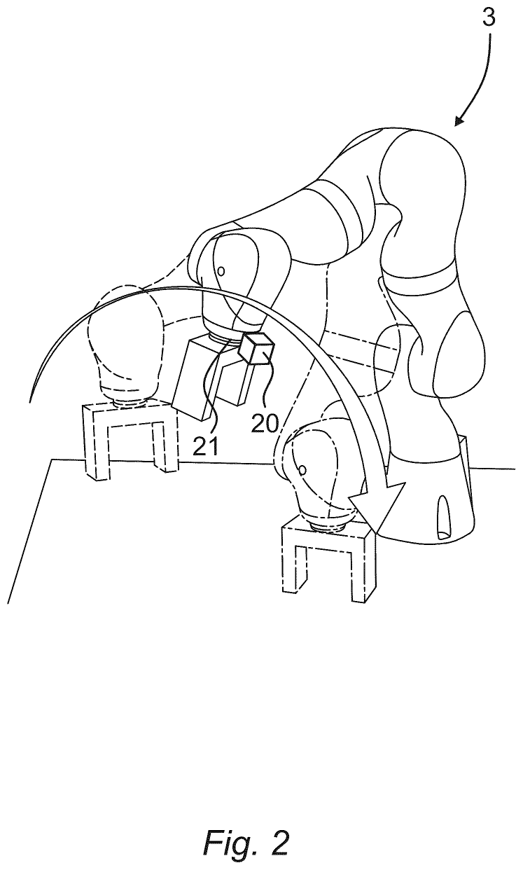

In the case of the embodiment according to FIG. 2, the robot arm 3 is designed as a robot arm 3 capable of human-robot collaboration, wherein a flange link 21 of the robot arm 3 has the coupled robot add-on part 20. The robot arm 3 is designed as, for example, a so-called lightweight robot. The robot arm 3 has a total of seven joints. The robot arm 3 is controlled by force/torque and can also be operated in a compliance control mode. In compliance control mode, the robot arm 3 can be manually moved by pushing and/or pulling on at least one link of the robot arm 3, and also changed in its current joint position configuration. In the exemplary type of coupling shown in FIG. 2, the robot add-on part 20 is coupled to the flange link 21 of the robot arm 3.

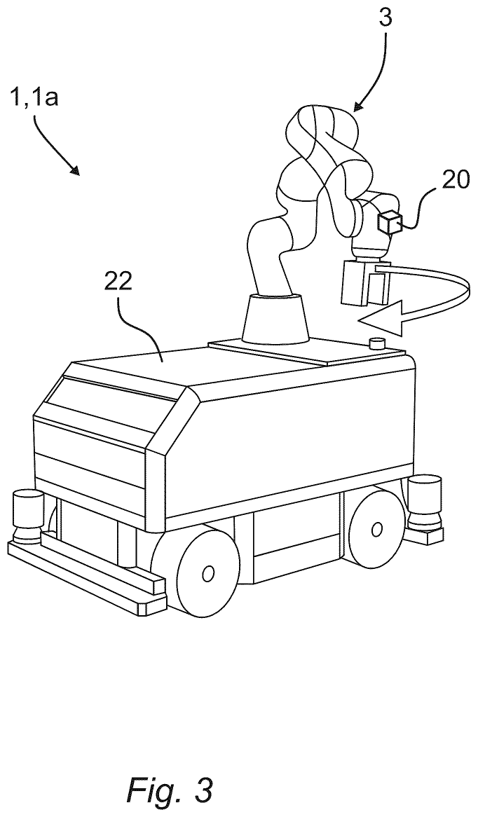

In another exemplary embodiment according to FIG. 3, the robot 1 is designed as a mobile robot 1a. It comprises as components an automatically controllable vehicle 22 and the robot arm 3, which is attached to the vehicle 22. The vehicle 22 can be an autonomous vehicle. By means of the vehicle 22, the robot arm 3 can be used at different locations. The robot add-on part 20 is, for example, coupled to a link of the robot arm 3 that is different from the flange link 21.

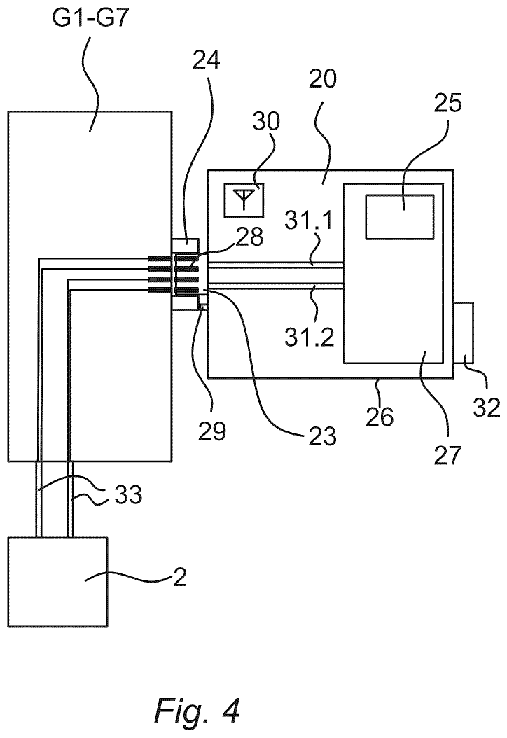

FIG. 4 schematically shows the robot add-on part 20 in an arrangement coupled to one of the links G1 to G7 on the robot arm 3.

The robot add-on part 20 has a casing 26 within which all components of the robot add-on part 20 are housed.

A coupling means 23 connectable in a form-fitting manner is arranged on the outside of the casing 26 and is designed for releasable coupling to at least one counter-coupling means 24 on an outer surface of a link G1 to G7 of the robot 3.

The coupling means 23 is designed, in a state coupled to the link G1 to G7 of the robot 3 as shown in FIG. 4, in cooperation with the corresponding counter-coupling means 24 of the link G1 to G7 of the robot 3, to arrange the robot add-on part 20 with regard to its position and orientation relative to the link G1 to G7 of the robot 3 to which the robot add-on part 20 is coupled in the coupled state, with a position and orientation accuracy sufficient for the positioning accuracy of the robot 3.

At least one control component 27 arranged in the casing 26 comprises a data memory 25 in which physical data of the robot add-on part 20 are stored.

A control interface 28 of the robot add-on part 20 is designed and configured to transmit the physical data of the robot add-on part 20 present in the data memory 25 to the control device 2 of the robot arm 3 when the robot add-on part 20 is coupled to the link of the robot arm 3.

The physical data can be geometry data, center of gravity data, load data, and/or machine data of the robot add-on part.

The robot add-on part 20 has a sensor 29 which is assigned to the coupling means 23 and designed to detect a proper coupling state of the coupling means 23 of the robot add-on part 20 to the counter-coupling means 24 of the link G1 to G7 of the robot 3, wherein the sensor 29 is configured to allow transmission of the physical data from the memory 25 of the robot add-on part 20 to the control device 2 assigned to the robot 3 when a proper coupling state of the coupling means 23 of the robot add-on part 20 to the counter-coupling means 24 of the link G1 to G7 of the robot 3 is detected by the sensor 29.

The control interface 28 of the robot add-on part 20 can be an electrical connector which is integrated into the coupling means 23 and via which, when the robot add-on part 20 is coupled to the link G1 to G7 of the robot 3, the physical data stored in the memory 25 are passed to the control device 2 by means of an electrical connection routed via the electrical connector.

The control interface 28 of the robot add-on part 20 can comprise a transmitting device 30 which is part of a wireless connection that connects the control component 27 of the robot add-on part 20 to the control device 2 of the robot 1.

The control interface 28 of the robot add-on part 20 can comprise a first data line 31.1, which is designed using non-secure technology and is configured to transmit data using non-secure technology to the control device 2 when the robot add-on part 20 is coupled to the link G1 to G7 of the robot 3, in order to register the robot add-on part 20 with the control device 2 using control technology and to transmit the physical data to the control device 2.

The control interface 28 of the robot add-on part 20 can further comprise a second data line 31.2, which is designed using secure technology and is configured to connect the control component 27 with at least one of its functionalities to the control device 2 using secure technology when the robot add-on part 20 is coupled to the link G1 to G7 of the robot 3.

The robot add-on part 20 can be designed, for example, as a manual operating device, a safety emergency switching device, a sensor, and/or a camera 32.

The control device 2 can be designed and configured to control electric motors M1 to M6 of the robot arm 3, which move the joints L2 to L6 of the robot arm 3 in order to adjust the links G1 to G7 of the robot arm 3 relative to each other either automatically according to a robot program implemented on the control device 2 or in a manual driving mode by manual control in order to move the robot arm 3 into different poses.

The control device 2 can comprise an input interface 33 to which the control interface 28 of the robot add-on part 20 is connected in the coupled state, such that data can be physically transmitted from the data memory 25 of the robot add-on part 20 to the control device 2.

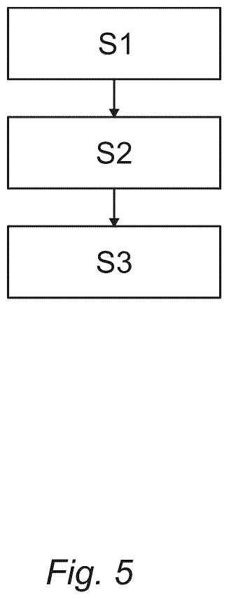

FIG. 5 illustrates the basic inventive method. The method serves to control electric motors M1 to M6 of the robot arm 3, which move the joints L1 to L6 of the robot arm 3 in order to adjust the links G1 to G7 of the robot arm 3 relative to each other either automatically according to a robot program implemented on the control device 2 or in a manual driving mode by manual control in order to move the robot arm 3 into different poses.

In a first step S1, the robot add-on part 20 is attached to a link G1 to G7 of the robot arm 2 comprising a plurality of links G1 to G7 by connecting, in a form-fitting manner, the coupling means 23 of the robot add-on part 20 to the counter-coupling means 24 of one of the links G1 to G7 of the robot arm 3.

In a second step S2, physical data is automatically transmitted from a data memory 25 of the robot add-on part 20 to the control device 2, which is designed and configured to control the robot arm 3 to which the robot add-on part 20 is coupled.

In a second step S2, the electric motors M1 to M6 of the robot arm 3 are controlled by means of the control device 2 automatically according to a robot program implemented on the control device 2 or in a manual driving mode by manual control, wherein during a controlled execution of movements of the robot arm 3, the physical data obtained from the robot add-on part 20 are included in the planning of the movements of the robot arm 3.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A robot add-on part, comprising:
a casing (26),
a coupling means (23) which is connectable in a form-fitting manner, arranged on the casing (26) and designed for releasable coupling to at least one counter-coupling means (24) on an outer surface of a link (G1-G7) of a robot (1),
wherein the coupling means (23) is designed, in a state coupled to the link (G1-G7) of the robot (1), in cooperation with the corresponding counter-coupling means (24) of the link (G1-G7) of the robot (1), to arrange the robot add-on part (20) with regard to its position and orientation relative to the link (G1-G7) of the robot (1) to which the robot add-on part (20) is coupled in the coupled state, with a position and orientation accuracy sufficient for the positioning accuracy of the robot (1),
at least one control component (27) which is arranged on the casing (26) or in the casing (26) and comprises a data memory (25) in which physical data of the robot add-on part (20) are stored, and
a control interface (28) which is designed and configured to transmit the physical data of the robot add-on part (20) present in the data memory (25) to a control device (2) of the robot (1) when the robot add-on part (20) is coupled to the link (G1-G7) of the robot (1).

2-10. (canceled)
